(19) United States
(12) Patent Application Publication
(10) Pub. No.: US 2004/0003150 A1
(43) Pub. Date: Jan. 1, 2004

(54) Appliance with built-in integrated communication port

(75) Inventor: Yuichiro Deguchi, San Mateo, CA (US)

Correspondence Address: Valley Oak Law, 5655 Silver Creek Valley Road, #106, San Jose, CA, 95138, US

(73) Assignees: Sony Corporation; Sony Electronics Inc.

(21) Appl. No.: 10/184,446

(22) Filed: Jun. 28, 2002

(51) Int. Cl. G06F 13/12

(52) U.S. Cl. 710/62

(57) ABSTRACT

A portable electronic device having integrated communication interface port for direct connection to a host device is provided. The portable electronic device includes a personal digital assistant, a mobile telephone, an electronic music marker device, and a portable e-mail device, where each of these devices are provided with a communication interface port integrated to the housing of the device such that the devices can be directly connected to a host device such as a desktop computer or a server terminal which are provided with complimentary interface ports.

### BACKGROUND OF THE INVENTION

1. Field of the Invention

The present invention relates to portable electronic devices. More particularly, the present invention relates to portable electronic devices and appliances with built-in, integrated communication port for direct connection to a host device for data transfer.

2. Description of the Related Art

In recent years, there has been a steady increase in the different types of multi-functional portable electronic devices such as personal digital assistants (PDAs), WAP (Wireless Application Protocol) enabled mobile telephones, i-mode mobile telephones, multi-functional portable radio and CD (Compact Disc) players such as Walkman®, MD (Mini Disc®) players and MP3 music players. With each new generation of these types of portable electronic devices, more features and functions are added such as wireless data exchange with other portable devices and host devices such as desktop computers and server terminals.

For example, PDAs introduced by Sony Corporation, Palm Inc., and Compaq Corporation, provide portable, high storage solution to traditional paper organizers with added functionality and increased portability. As with most information stored in electronic devices, data backup and exchange play a significant role in using these PDAs. For example, most, if not all PDAs commercially available today require a docking cradle type device to which the PDAs connect for data communication with host devices such as desktop computers. In this manner, data entered into a PDA can be backed up and stored in the personal computer through a cable connection via the cradle by a so-called hot sync operation. Recent explosion in the use of mobile telephones have seen similar devices an cables which allow connection of the mobile telephones to a personal computer for data backup and data upload. While portability of these types of devices is important, routine communication with the host device for data backup and transfer may be equally as significant as the information stored in the portable devices..

While PDAs and mobile telephones are some examples of portable electronic devices for storing data, other portable electronic devices have recently been commercially introduced with additional functionality beyond storing information such as calendaring, memo pads, calculator functions and so on. For example, recent introduction of an e-marker device by Sony Corporation and its U.S. subsidiary, Sony Electronics, Inc., which is capable of “bookmarking” a music clip while being played on a radio has added to the available portable electronics devices. Briefly, the e-marker is capable of recalling the information related to the bookmarked music clip such as the name of the song, the artist, the album containing the song and so on. Using the e-marker, a user can conveniently access the music clip information that the user listened to on the radio at a later time without the need to memorize the information or wait hopefully for the disc jockey on the radio station to provide that information. In this manner, if the user wishes to, for example, purchase the music album which the user has marked using the e-marker, the user can easily identify the necessary information related to the marked music clip from the e-marks provided by the e-marker.

The presently available e-marker devices are provided with a USB port for connection to a gateway device such as a personal computer and the like for accessing the user's e-marker account over an internet connection. The existing configuration of the e-marker devices is such that the device itself must be plugged into a cradle which, in turn, is connected to the personal computer's input port such as a USB port, thus allowing transfer of the data stored in the e-marker device to the user's e-marker account accessed at www.emarker.com website.

Referring to FIG. 1, there is shown e-marker device 1A and cradle 1B. E-marker device 1A is provided with a housing comprising body 101 and cap 102. Body 101 is provided with e-mark button 103 which is configured for user input commands. Also, as shown, there are provided on body 101 display panels 104a and 104b which are configured to display the number of user inputted e-marks and the type of registered broadcast station (for example, radio or television station) for the corresponding e-marks, respectively. Finally, body 101 includes USB port 105 which provided onto body 101 such that body 101 may be placed on top of cradle 1B with female USB port 105 capable of being plugged into the corresponding male port on cradle 1B.

Cap 102 may be attached to body 101 when access to USB port 105 is unnecessary. As shown, cap 102 is provided with a pair of release/lock buttons 106 on either side of cap 102 such that by depressing release/lock buttons 106 when cap 102 is locked with body 101, cap 102 can be released from a locked position and access to USB port 105 can be obtained. Furthermore, cap 102 is provided with hole 107 substantially at its edge position such that link chain 108 can be looped through hole 107 to allow the user to attach e-marker device 1A to a key chain or the like.

Referring back to FIG. 1, cradle 1B is provided with cradle base 110 substantially flat on its bottom surface (not shown) to rest cradle 1B on a flat surface such as a desktop or a book shelf. On the other side of the bottom surface of cradle 1B is receiving section 111 substantially positioned on the middle of cradle 1B, where male USB port 112 is provided for connection to female USB port 105 of the e-marker device. Also shown in FIG. 1 is cable 113 attached to cradle 1B with male USB port 114 at its other end. In this manner, cradle 1B can be connected to a gateway device such as a personal computer for accessing the user's e-marker account over an internet connection.

With the e-marker device connected to cradle 1B via the pair of USB ports, 105, 112, the e-marker device can transfer user marked data (for example, data marks) to the user's e-marker account by connecting USB port 114 of cradle 1B to a corresponding USB port (not shown) of the personal computer or other peripheral device which can provide access to the user's e-marker account over an internet connection.

FIG. 2 illustrates a personal digital assistant with a cradle for connection to a host device. Referring to FIG. 2, personal digital assistant 2A is provided with body 201 including display unit 202 and input unit 203. Input unit 203 may be operated to input data into personal digital assistant 2A. Further shown in FIG. 2 is serial interface communication port 204 provided substantially on the bottom end of body 201 of personal digital assistant 2A. Also shown in FIG. 2 is docking cradle 2B having base 205 and docking operation unit 206 and interface communication port 207. Docking cradle 2B is also provided with cord 208 attached thereto, cord 208 having attached at its other end interface communication port 209 which connects to a complimentary interface port at a host device (not shown) such as, for example, a personal computer. Typically, interface communication port 209 of docking cradle 2B may be either a serial port or a parallel port, and likewise, host devices generally include either a serial port or a parallel port, or in some instances, both serial and parallel ports.

When personal digital assistant 2A is in a docked position such that serial interface communication port 204 of personal digital assistant 2A is coupled to interface communication port 207 of docking cradle 2B, by operating docking operation unit 206, data from personal digital assistant 2A may be transmitted to the host device via the cable connection with cord 208 of docking cradle 2B. In this manner, data stored in personal digital assistant 2A may be backed up and synchronized with data in the host device. Alternatively, with operation from the host device, data may be transferred in the opposite direction from the host device to personal digital assistant 2A.

In this manner, personal digital assistants and other portable electronic devices generally require an intermediary cable connection to communicate with a host device for data transfer, exchange and the like. With the rise in the number of different types of such devices, it would be desirable to provide portable electronic devices or appliances which have integrated communication port for direct connection to a host device for data exchange and storage without the need for an intermediary type connection such as a cradle.

### SUMMARY OF THE INVENTION

In view of the foregoing, a portable appliance is provided with an integrated communication port for direct communication to a host device such as a computer or other similar types of devices for data transfer.

In particular, a portable electronic device of one embodiment includes a housing, and a communication interface port integrated to the housing for direct connection to a host device. A method of another embodiment includes directly connecting a communication port integrated to a portable device to an interface port of a host device, and transferring data between the portable device and the host device. A portable electronic device of yet another embodiment includes means for housing a portable device, and means for communicating integrated to the housing means for direct connection to a host device.

These and other features and advantages of the present invention will be understood upon consideration of the following detailed description of the invention and the accompanying drawings.

### BRIEF DESCRIPTION OF THE DRAWINGS

FIG. 1 illustrates an e-marker device and a docking cradle;

FIG. 2 illustrates a personal digital assistant and a docking cradle;

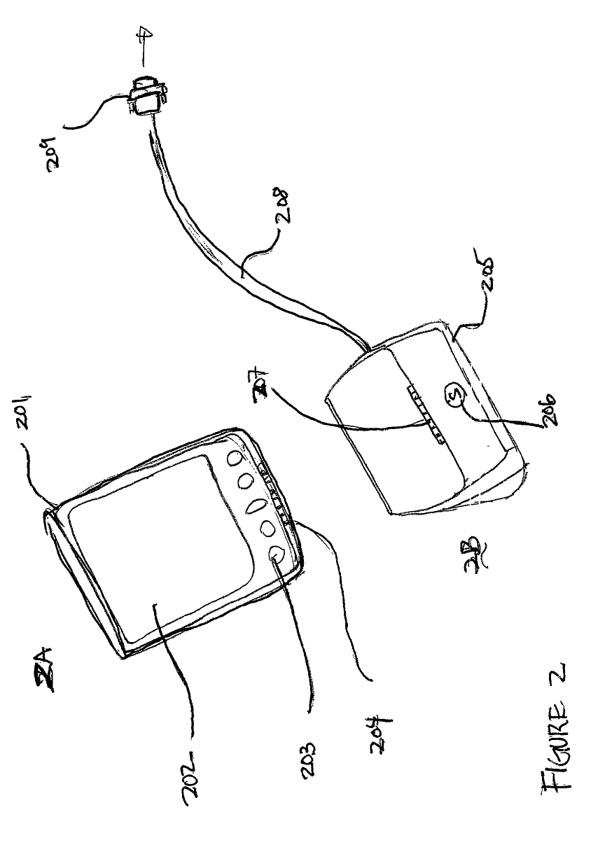

FIG. 3 illustrates a portable appliance with integrated USB interface communication port; FIG. 4 illustrates a portable appliance with integrated IEEE 1394 interface communication port;

FIG. 5 illustrates a portable appliance with integrated PCMCIA interface communication port;

FIG. 6 illustrates a portable appliance with integrated IrDA interface communication port;

FIG. 7 illustrates a portable appliance with integrated Bluetooth interface communication port;

FIGS. 8 is a flow chart for illustrating one embodiment of the portable electronic music marker device with built-in, integrated communication port operation; and

FIG. 9 is a flow chart for illustrating one embodiment of downloading data from the user's e-marker account to the portable electronic music marker device with built-in integrated communication port.

### DETAILED DESCRIPTION

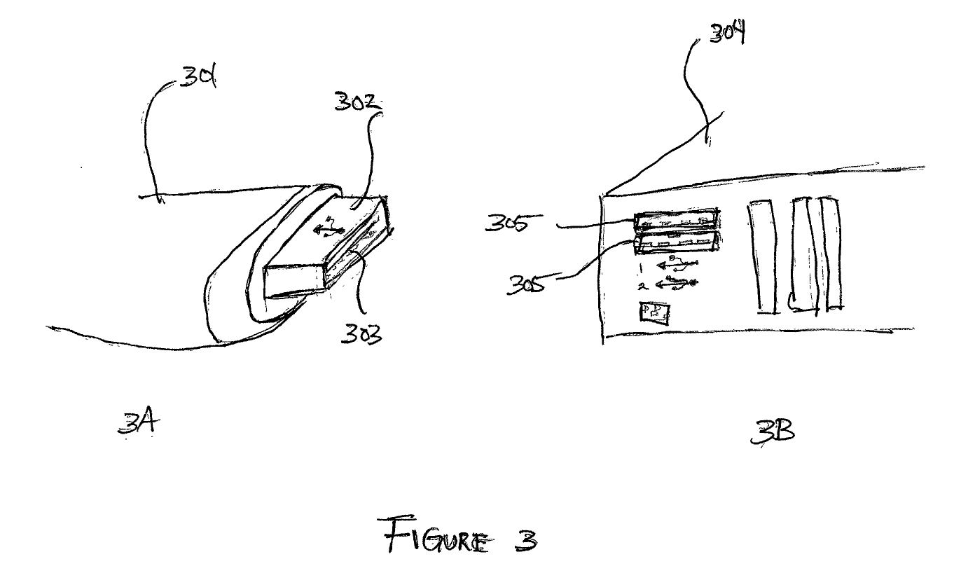

FIG. 3 illustrates a portable appliance with integrated USB interface communication port. Referring to FIG. 3, portable device 3A includes device body 301 and communication port 302 incorporating USB port 303 integrated onto device body 301. As shown, USB port 303 which is physically integrated into device body 301 of portable device 3A is a male port. Also shown in FIG. 3 is host device 3B which includes housing 304 and a pair of USB ports 305 provided thereon. Host device 3B may be a personal computer, a server terminal, or any other type of device which is capable of communicating with portable device 3A for data exchange, and which, in one embodiment, may further be configured to access the internet via data protocol such as TCP/IP. USB ports 305 may be provided on a front panel or a side panel of housing 304 of host device 3B such that a user can easily access USB ports 305. Moreover, in one embodiment, USB ports 305 maybe provided on a top panel of housing 304 of host device 3B such that for portable device 3A which is relatively heavy such as personal digital assistants and mobile telephones (as compared to electronic music markers and mobile email devices such as Blackberry), stress on USB ports 305 may be lessened or largely avoided.

In the manner shown in FIG. 3, in one embodiment, portable device 3A may be configured to directly connect to host device 3B by connecting male USB port 303 (which may be an “A” USB connector) of portable device 3A to female USB port 305 of host device 3B for exchanging data. Since USB ports are hot swappable and plug-and-play type interface ports, not requiring a reboot procedure or re-initialization procedure at host device 3B when portable device 3A is connected and disconnected, a user may conveniently connect portable device 3A directly to host device 3B and disconnect any number of times without performance degradation while fully supporting data exchange (supporting data transfer rate of approximately 12 Megabits per second) between portable device 3A and host device 3B.

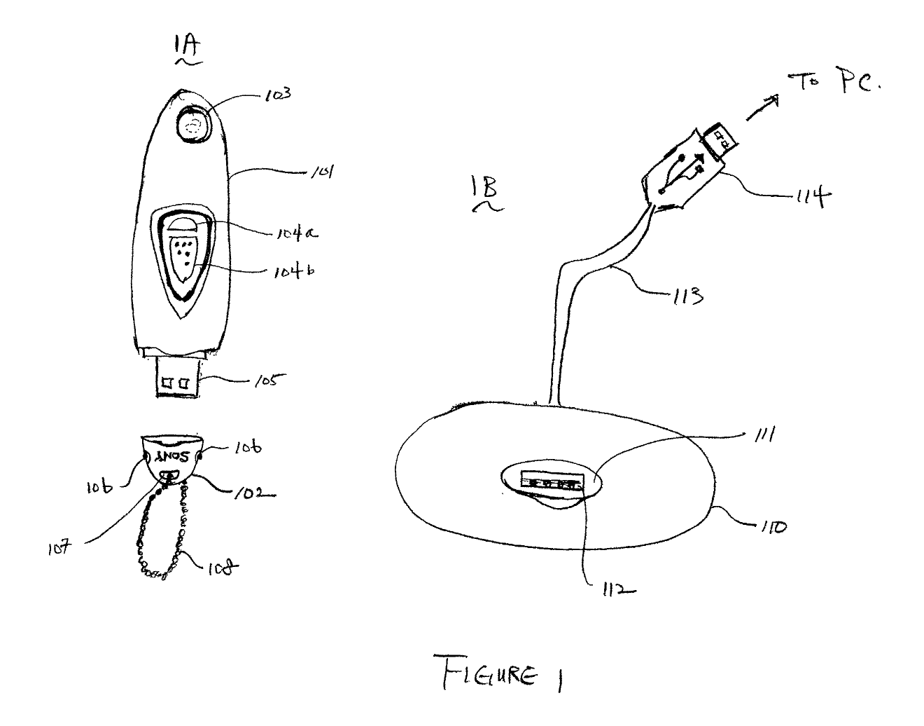

In one embodiment, portable device 3A may include electronic music marker device capable of bookmarking music clip broadcasts over a registered radio or television station. In particular, when a user hears a music clip broadcast and wishes to bookmark the particular music clip, the user operates an input unit (not shown) which is similar to e-mark button 103 shown in FIG. 1. With each operation of the input unit by the user to bookmark desired music clip broadcasts, an indication of the inputted bookmark may be displayed on a display unit (not shown) similar to display panels 104a, 104b shown in FIG. 1.

To retrieve information related to the bookmarked music clips, the user may directly connect electronic music marker device 3A (portable device 3A) to host device 3B such as a desktop personal computer with established connection to the internet. In particular, the user may directly connect male USB port 303 on communication port 302 attached to electronic music marker device 3A to one of female USB ports 305 at host device 3B. Thereafter, when the user enters the user's e-marker account information and accesses the user's e-marker account via the host device 3B at www.emarker.com web site, the data marks (bookmarks) representing bookmarked music clips may be transferred to the user's e-marker account. The information related to the bookmarked music clips may then be displayed at a display terminal (not shown) of host device 3B, such information including, for example, the title of the bookmarked music clip, the name of the artist of the bookmarked music clip, the name of the album of the bookmarked music clip, billboard chart information related to the bookmarked music clip, and ordering information to purchase a CD of the music clip such as a direct website link information to a vendor such as Amazon.com and CDNow.com. Moreover, in one embodiment, data related to the bookmarked music clips may be transferred to electronic music marker device 3A such that at data corresponding to the respective bookmarked music clips may be displayed on display panels on electronic music marker device 3A.

Additional information relating to the operation of the e-marker device can be found in pending application Ser. No. 09/126,007 filed on Jul. 29, 1998 and application Ser. No. 09/401,103 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

In the manner described above, in one embodiment, portable device 3A such as an electronic music marker, a personal digital assistant, a mobile telephone, and other types of portable electronics devices may be provided with a male USB port integrated into the device body such that the devices may be directly connected to a complimentary communication port on the host device such as a personal computer or a server terminal. Indeed, since the communication port is integrated into the portable device, a user can significantly enhance the portability and functionality of the portable device, eliminating the need for a docking cradle type unit for connection to a host device for backup data transfer as well as for other types of data communication.

FIG. 4 illustrates a portable appliance with integrated IEEE 1394 interface communication port. As shown, portable device 4A includes device body 401 and integrated communication interface 402 attached to one end of device body 401. IEEE 1394 interface communication port 403 is provided on integrated communication interface 402 of portable device 4A. In one embodiment, interface communication port 403 may include i.Link® interface communication port available from Sony Corporation of Japan or Firewire interface port available from Apple Computer, Inc., of Cupertino, Calif. Also shown in FIG. 4 is host device 4B which includes housing 404 and a pair of USB ports 407 similar to host device 3B of FIG. 3. Further provided on housing 404 of host device 4B is IEEE 1394 interface communication port 406 for connection to interface communication port 403 of portable device 4A. Interface communication port 406 may be a 6-pin socket for cases where host device 4B is a desktop computer or a server terminal, and alternatively, may be a 4-pin socket in the case where host device 4B is a portable laptop computer, for example.

While not shown, host device 4B includes a physical layer and a link layer semiconductor chip to support 1394 connection at data transfer rates of, for example, 25 Mbits/second to 400 Mbits/second. In particular, the physical layer chip is a mixed signal device that supports multiple 1394 ports. it includes the logic needed to perform arbitration and bus initialization functions. The link layer chip may be configured to transmit and receive 1394-formatted data packets and supports isochronous or asynchronous data transfers between portable device 4A and host device 4B.

While both USB ports 303, 305 shown in FIG. 3 and IEEE 1394 interface communication ports 403, 406 shown in FIG. 4 are serial buses, IEEE 1394 interface communication ports 403, 406 can move more data in a given amount of time as compared to data transfer using USB ports 303, 305. On the other hand, data exchange using IEEE 1394 interface communication ports 403, 406 between portable device 4A and host device 4B require more complex protocol and signaling rate than that for data communication between USB ports 303, 305 of portable device 3A and host device 3B, respectively.

Moreover, similar to the USB connections, data communication between 1394 interface communication ports 403, 406 may be based on packet transmission between portable device 4A and host device 4B. In particular, 1394 interface communication bus may define a “transaction” software-service layer, which presents client software with three basic services—read, write and lock. Each of these services may be, in turn, translated into sequences of packets in a “link” software layer. Then, the packets may be transmitted over a physical line (copper wires or fiber-optic cable) through a “physical” hardware layer (PHY). In this manner, the hardware/software “stack” may support both asynchronous communication and optionally isochronous communication.

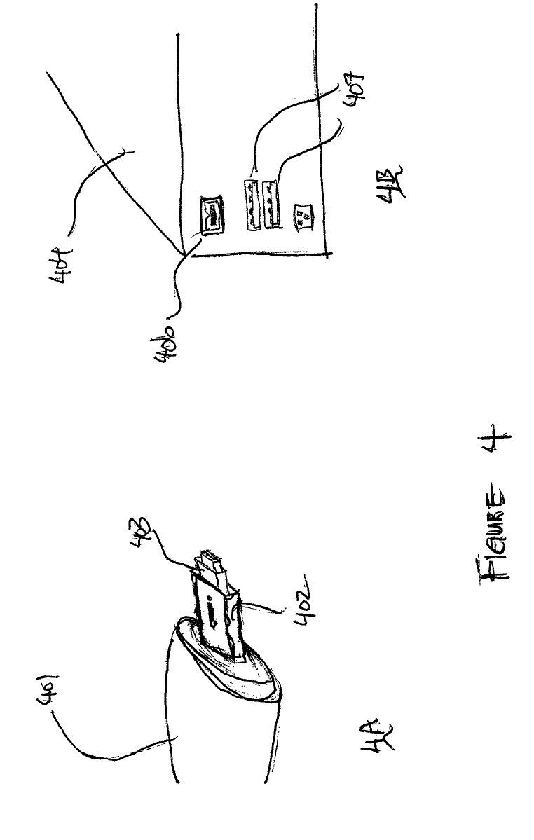

FIG. 5 illustrates a portable appliance with integrated PCMCIA (Personal Computer Memory Card International Association) interface communication port. Referring to FIG. 5, portable device 5A is provided with device body 501, and attached to device body 501 is integrated PCMCIA communication port 502. Also shown in FIG. 5 is host device 5B including housing 508 and a pair of PCMCIA slots 503 along a side surface of housing 508. Host device 5B may include a portable laptop computer device or handheld computer device having PCMCIA slots incorporated into the housing of the device.

As shown, each PCMCIA slot 503 includes load/eject button 504 which is configured to operably receive and/or eject PC cards 506 provided in the corresponding PCMCIA slot 503. In particular, a user may operate load/eject button 504 to eject PC card 506 loaded in PCMCIA slot 503. Alternatively, the user may insert PC card 506 into a respective PCMCIA slot 503 by exerting a light force on the end of PC card 506 so that PC card 506 securely latches in the respective PCMCIA slot 503. In one embodiment, host device 5B may be configured such that when the user places PC card 506 partly in PCMCIA slot 503, host device 5B detects the presence of PC card 506 and loads PC card 506 in the respective PCMCIA slot 503 automatically.

Referring back to FIG. 5, PC card 506 is provided with interface communication port 507 substantially along a side surface parallel to the side surface of host device 5B. Accordingly, integrated PCMCIA communication port 502 of portable device 5A may be configured to adaptively couple to interface communication port 507 of PC card 506 loaded in host device 5B. In this manner, portable device 5A and host device 5B may be configured to directly exchange data via PCMCIA connection for data backup, updating and so on. PC cards 506 may be Type I, Type II or Type III cards, each configured to operate with compatible card and socket services software loaded in host device 5B, and depending upon design, may be configured to support data transfer rate of up to approximately 850 Mbits/second. For example, card services may be configured to manage system resources required by PC card 506, and on host device 5B, may determine which IRQs and memory and I/O addresses are assigned. Card services may also be configured to manage hot swapping and pass changes in event to higher-level drivers designed for specific cards. Additionally, card services may communicate with socket services which is the lowest level of software that communicates directly with PC card 506 controller chips. It should also be noted that socket services may be built into the system BIOS of host device 5B or loaded onto host device 5B by software.

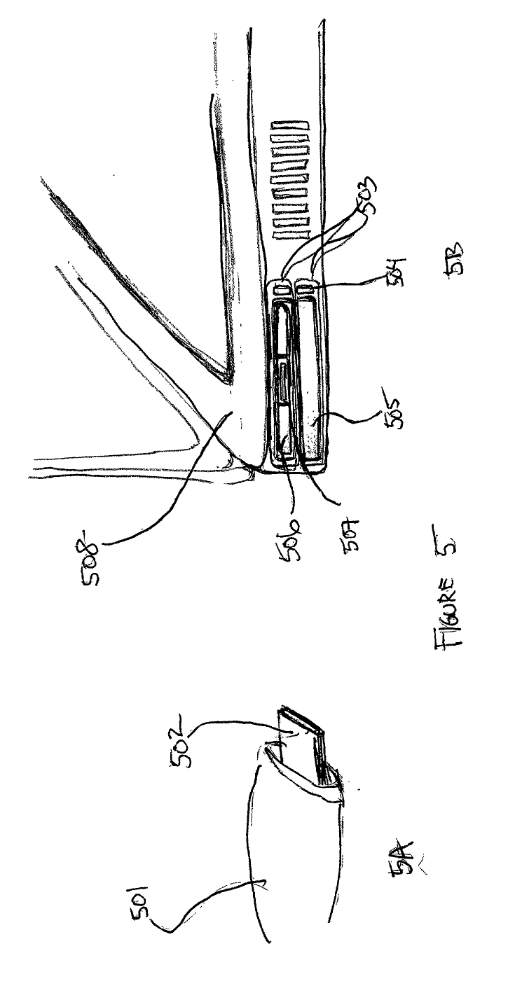

FIG. 6 illustrates a portable appliance with integrated IrDA (Infrared Data Association) interface communication port. Referring to FIG. 6, portable device 6A including device body 601 and communication port 602 integrated onto device body 601. Communication port 602 includes infrared data transfer interface port 603 and infrared transmitter and receiver (transceiver) 606 for performing data and information exchange modulated onto infrared spectrum. Also shown in FIG. 6 is host device 6B including housing 604, and provided thereon is infrared communication interface port 605.

Similar to communication port 602 of portable device 6A, infrared communication interface port 605 further includes infrared transmitter and receiver (transceiver) 607 to enable data transmission and reception via infrared communication interface port 605.

Accordingly, in one embodiment, using infrared data transfer interface port 603 of portable device 6A and infrared communication interface port 605 of host device 6B, a user may perform wireless communication directly between portable device 6A and host device 6B for data transfer and exchange. In particular, the user may align infrared data transfer interface port 603 of portable device 6A with infrared communication interface port 605 and operate a data communication input unit 608 provided on device body 601 of portable device 6A (or alternatively, similar data communication input unit 609 may be provided on housing 604 of host device 6B) for data transfer, with transfer rate of up to approximately 10 Mbits/second.

In upstream data transmission from portable device 6A to host device 6B, infrared transceiver 606 may be configured to modulate and transmit the user specified or designated data stored in portable device 6A via infrared data transfer interface port 603 for reception and demodulation by infrared transceiver 607 of host device 6B via infrared communication interface port 605. Host device 6B may, in turn, transmit the received data to a server terminal (not shown) via an internet connection under protocols such as TCP/IP, and likewise, may also store the received data in its own data storage unit (not shown). Alternatively, data may be transmitted in the opposite downstream direction from host device 6B to portable device 6A. In this case, infrared transceiver 607 of host device 6B may be configured to modulate the data to be transferred to portable device 6A, and transmit the modulated data to infrared data transfer interface port 603 of portable device 6A via infrared communication interface port 605 of host device 6B. In one embodiment, portable device 6A may be configured to process the received data, for example, for display onto its display unit (not shown) or for storage in a data storage unit (not shown). In this manner, information may be directly transferred between portable device 6A and host device 6B without the need for an intermediary data bus, cable or docking cradle type device.

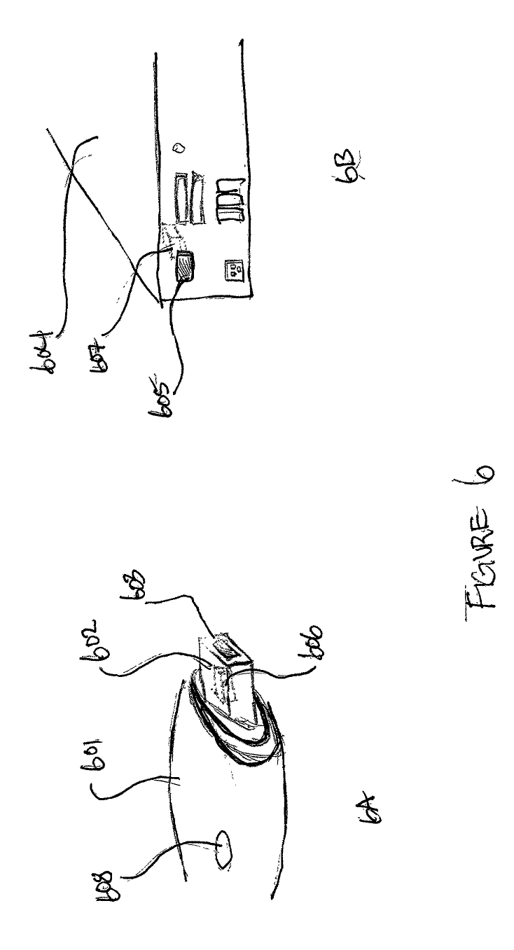

FIG. 7 illustrates a portable appliance with integrated Bluetooth interface communication port. Referring to FIG. 7, portable device 7A includes device body 701, input unit 702 and display unit 703. Provided within device body 701 is Bluetooth transceiver 704 for performing spread spectrum transmitting, for example, as discussed below. Also shown in FIG. 7 is host device 7B including housing 705 which is also provided with peripheral interface ports 707, expansion slots 708 and power socket 709. Provided within housing 705 of host device 7B is Bluetooth transceiver 706 for communicating with portable device 7A.

With the ability to perform spread-spectrum frequency hopping, Bluetooth enabled data communication system as shown in FIG. 7 allows wireless data exchange over relatively short distances. In particular, using radio frequencies, Bluetooth enabled systems are configured to create a Personal-Area-Network (PAN), otherwise referred to as “piconet” that may fill a room or may encompass a distance of up to approximately 33 feet. Once a piconet is established, the Bluetooth enabled devices (in this case, portable device 7A and host device 7B) may be configured to automatically and randomly hop frequencies in unison so that they stay in touch with one another while avoiding other piconets that may be operating in the same room or area.

Referring back to FIG. 7, Bluetooth transceivers 704, 706 may be configured with an address that falls within a range of addresses for portable device 7A and host device 7B. When the user carrying portable device 7A moves close to the location of host device 7B, a piconet between these two devices is automatically established without the need for the user to operate or input a command. Having established the data communication channel between portable device 7A and host device 7B, data may be directly transferred in either direction. The communication data channel shared by portable device 7A and host device 7B may have a total capacity of 1 Megabit/second, operating, as discussed above, in radio frequency such that the data channel hops randomly 1,600 times per second between the 79 RF channels (or 23 1-MHz RF channels in Japan).

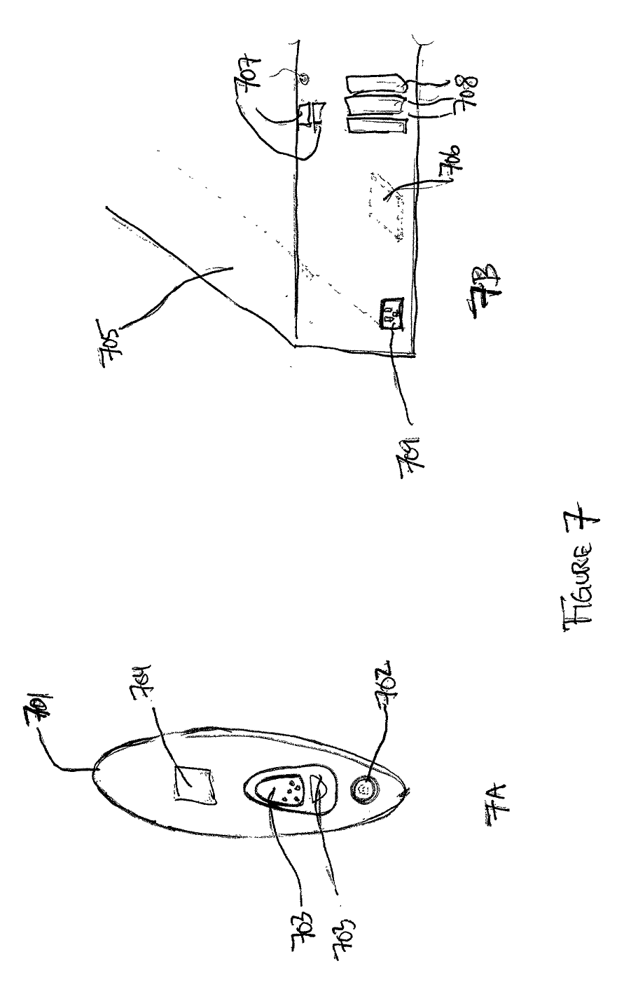

FIG. 8 is a flow chart for illustrating one embodiment of the portable electronic appliance (for example, electronic music marker device 3A) with integrated communication port 302 operation. Referring to FIGS. 3 and 8, at step 801, electronic music marker device 3A detects user's input operation of an input unit (similar to e-mark button 103 of FIG. 1). Then, at step 802, electronic music marker 3A illuminates or flashes a corresponding e-mark display panel (similar to display panels 104a, 104b). In one embodiment, the corresponding e-mark display panels may also display time and/or date information of the user's input operation of the input unit of electronic music marker.

At step 803, electronic music marker 3A determines whether all available e-mark display panels are being used (for example, illuminated or flashing in response to user's operation of input unit). If it is determined that there are available e-mark display panels, electronic music marker 3A waits for further input operation by the user at step 801. On the other hand, if it is determined at step 803 that all available e-mark display panels are in use, then at step 804, electronic music marker 3A generates an output signal to inform the user that electronic music marker 3A has reached its maximum number of e-marks that it can handle, and the procedure ends. In one embodiment, the output signal from electronic music marker 3A to inform the user that it has reached its maximum number of e-marks (bookmarks) it can handle may be an audible output signal such as an audible tone via an audio output terminal (not shown). Alternatively, electronic music marker 3A may be configured to flash all e-mark display panels simultaneously for a predetermined period of time to visually indicate to the user that it has reached its maximum number of e-marks that it can handle.

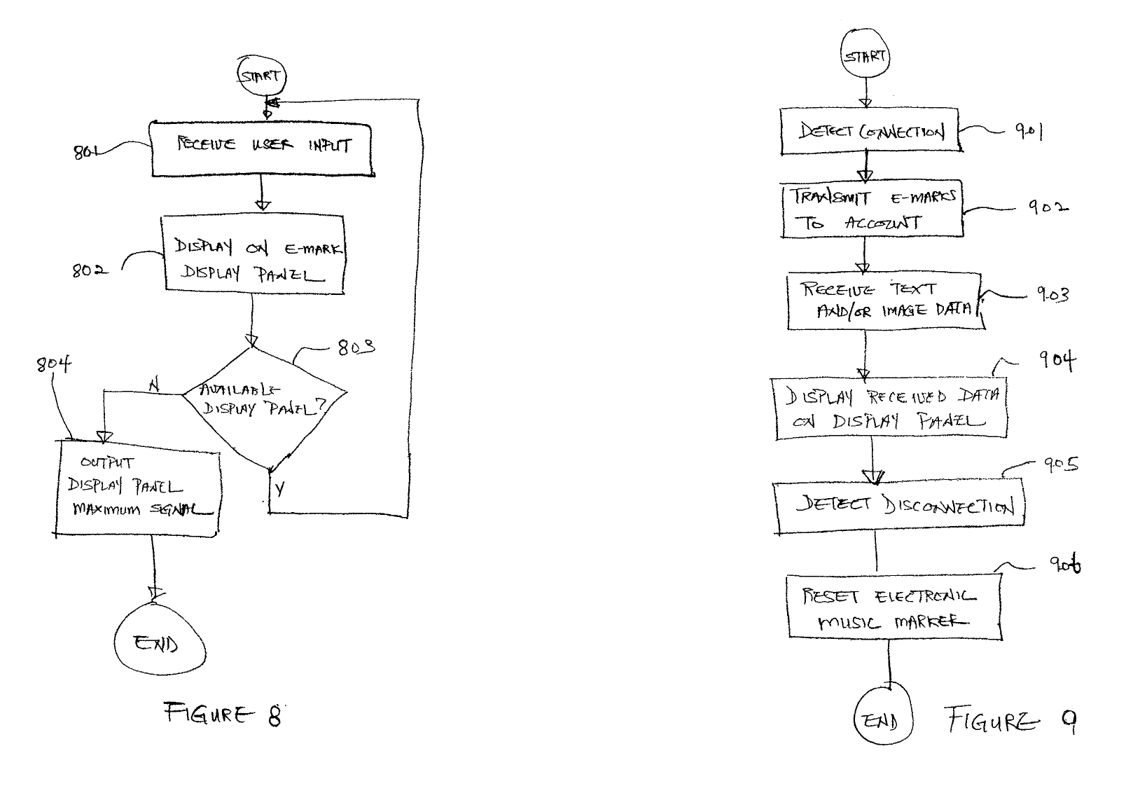

FIG. 9 is a flow chart illustrating one embodiment of downloading data from the user's e-marker account to electronic music marker 3A when directly connected to host device 3B. Referring to FIGS. 3 and 9, at step 901, electronic music marker 3A detects a direct connection to host device 3B, and after the user enters the user's account information and performs necessary e-marker account access steps at host device 3B, at step 902, data corresponding to the e-marks (bookmarks) stored in electronic music 3A is transmitted to the user's e-marker account via a direct connection of USB ports 303, 305 through host device 3B, and in response, the corresponding text and/or image (including video) data are retrieved from a server terminal of e-marker.com's web site and transmitted to the user's e-marker account. Then, at step 903, the text and/or image data corresponding to each e-marks are downloaded onto electronic music marker 3A (in addition to being displayed on display terminal of host device 3B). At step 904, the downloaded text and/or image data are displayed on each corresponding e-mark display panel on electronic music marker 3B.

When the user disconnects electronic music marker 3A from host device 3B, the termination of the direct connection of USB ports 303, 305, respectively attached to electronic music marker 3A and host device 3B is detected at step 905. Then, at step 906, electronic music marker 3A is reset such that previously stored e-marks inputted by the user may be erased from electronic music marker 3A, and correspondingly, the illuminated e-mark display panels may be turned off. The user may then operate the input unit of electronic music marker 3A again to input additional bookmarks of music clip broadcasts from registered radio and television broadcast stations.

In the manner described above, a portable electronic device having integrated communication interface port for direct connection to a host device is provided. The portable electronic device may include a personal digital assistant, a mobile telephone, an electronic music marker device, and a portable e-mail device, where each of these devices are provided with a communication interface port integrated to the housing of the device such that the devices can be directly connected to a host device such as a desktop computer or a server terminal which are provided with complimentary interface ports. Furthermore, as discussed above, the integrated communication interface port provided on the portable electronic device may include a USB port, an IEEE 1394 interface port, a PCMCIA interface port, an IrDA interface port and a Bluetooth interface port, with the host device provided with a corresponding complimentary interface port for direct communication with the portable device.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A portable electronic device, comprising:
a housing; and
a communication interface port integrated to said housing for direct connection to a host device.

2. The device of claim 1 wherein said direct connection includes one of a physical connection and a wireless connection.

3. The device of claim 1 wherein said host device includes a host interface port for connecting to said communication interface port.

4. The device of claim 3 wherein said communication interface port is a male USB port and said host interface port is a female USB port.

5. The device of claim 4 wherein said direct connection is configured to support a data transfer rate of up to approximately 12 Mbits/second.

6. The device of claim 3 wherein each of said communication interface port and said host interface port is an IEEE 1394 interface port.

7. The device of claim 6 wherein said direct connection is configured to support a data transfer rate of approximately 25 Mbits/second to 400 Mbits/second.

8. The device of claim 3 wherein each of said communication interface port and said host interface port is a PCMCIA interface port.

9. The device of claim 8 wherein said direct connection is configured to support a data transfer rate of approximately 850 Mbits/second.

10. The device of claim 3 wherein each of said communication interface port and said host interface port is an infrared interface port.

11. The device of claim 10 wherein said direct connection is configured to support a data transfer rate of approximately 10 Mbits/second.

12. The device of claim 3 wherein each of said communication interface port and said host interface port is a Bluetooth interface port.

13. The device of claim 12 wherein said direct connection is configured to support a data channel of approximately 1 Mbits/second.

14. The device of claim 12 wherein said direct connection is configured to operate at a frequency 2.45 GHz.

15. The device of claim 1 wherein said portable device includes one of a personal digital assistant, a mobile telephone, an electronic music marker, and a mobile pager device, and further wherein said host device includes one of a personal computer and a server terminal.

16. A method, comprising:
directly connecting a communication port integrated to a portable device to an interface port of a host device; and
transferring data between said portable device and said host device.

17. The method of claim 16 wherein said data transferring step includes:
detecting said connection between said communication port and said interface port; and
initiating data transfer between said portable device and said host device.

18. The method of claim 16 further comprising disconnecting said communication port of said portable device from said interface port of said host device.

19. The method of claim 18 wherein said disconnecting step includes:
detecting a data transfer termination signal; and
separating said communication port from said interface port.

20. The method of claim 16 further including:
connecting to a server terminal; and
transferring data received from said portable device to said server terminal.

21. The method of claim 20 further including receiving data from said server terminal corresponding to transferred data.

22. The method of claim 16 wherein said data transferred from said portable device to said host device includes at least one data mark.

23. The method of claim 16 wherein said directly connecting step includes establishing one of a physical communication connection and a wireless communication connection between said portable device and said host device.

24. The method of claim 23 wherein said physical communication connection includes one of a USB interface connection, IEEE 1394 interface connection, and a PCMCIA interface connection, and further, wherein said wireless communication connection includes one of an infrared communication connection and a piconet personal area network.

25. A portable electronic device, comprising:
means for housing a portable device; and
means for communicating integrated to said housing means for direct connection to a host device.
